(19) United States
(12) Patent Application Publication
(10) Pub. No.: US 2015/0277914 A1
(43) Pub. Date: Oct. 1, 2015

(54) LOCK ELISION WITH BINARY TRANSLATION BASED PROCESSORS

(71) Applicants: John H. Kelm, Sunnyvale, CA (US); Naveen Neelakantam, Mountain View, CA (US); Denis M. Khartikov, San Jose, CA (US)

(72) Inventors: John H. Kelm, Sunnyvale, CA (US); Naveen Neelakantam, Mountain View, CA (US); Denis M. Khartikov, San Jose, CA (US)

(21) Appl. No.: 14/227,014

(22) Filed: Mar. 27, 2014

(51) Int. Cl. G06F 9/30

(52) U.S. Cl. CPC G06F 9/30181; G06F 9/30072

(57) ABSTRACT

Generally, this disclosure provides systems, devices, methods and computer readable media for detection and exploitation of lock elision opportunities with binary translation based processors. The device may include a dynamic binary translation (DBT) module to translate a region of code from a first instruction set architecture (ISA) to translated code in a second ISA and to detect and elide a lock associated with a critical section of the region of code. The device may also include a processor to speculatively execute the translated code in the critical section. The device may further include a transactional support processor to detect a memory access conflict associated with the lock and/or critical section during the speculative execution, roll back the speculative execution in response to the detection, and commit the speculative execution in the absence of the detection.

### FIELD

The present disclosure relates to lock elision, and more particularly, to detection and exploitation of lock elision opportunities with binary translation based processors.

### BACKGROUND

Computing systems often have multiple processors or processing cores over which a given workload may be distributed to increase computational throughput. Multiple threads or processes may execute in parallel on each of the processor cores and may share common regions of memory. Locks are typically used for synchronization and protection of these critical sections of memory from conflicting access by two or more processors. The use of such locks, however, generally results in performance degradation due to memory access serialization across the multiprocessor system and the coherence traffic associated with multiple threads checking and waiting for lock availability.

Although the locks may incur a relatively high runtime cost, they are often not necessary for correct program execution because the multiple threads may access data from different (disjoint) regions of the critical sections or the access may not involve read-write conflicts. Some processors use transactional semantics that allow software developers to include annotations in the code to indicate that a lock variable may be elided by hardware. This approach, however, requires that software be modified to support that capability, which may be expensive or impractical, and otherwise provides no benefit to legacy code. Furthermore, programmers may inadvertently use these annotations to indicate lock elision opportunities that can actually result in dynamic conflicts at runtime which were unknown statically. Such incorrectly elided locks may further degrade performance.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one example embodiment consistent with the present disclosure;

FIG. 2 illustrates a block diagram of one example embodiment consistent with the present disclosure;

FIG. 3 illustrates a translation region of another example embodiment consistent with the present disclosure;

FIG. 4 illustrates a block diagram of another example embodiment consistent with the present disclosure;

FIG. 5 illustrates a block diagram of another example embodiment consistent with the present disclosure;

FIG. 6 illustrates a flowchart of operations of one example embodiment consistent with the present disclosure; and

FIG. 7 illustrates a top level system diagram of a platform of another example embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems, devices, methods and computer readable media for detection and exploitation of lock elision opportunities with binary translation based processors. Locks enable synchronization and protection of critical sections of code, memory or other resources, from conflicting access by multi-threaded application which may be executing on multiple processors or processor cores. Lock elision, as described in the present disclosure, may provide the capability for hardware, software or some combination therein, to avoid synchronization overheads without requiring user-visible semantic modifications to the application software, as required in traditional Hardware Lock Elision (HLE) systems. In this sense, the lock elision of the present disclosure may be considered automatic.

As will be described in greater detail below, a portion of the lock elision process may be performed during dynamic binary translation (DBT) of the application software from a public instruction set architecture (ISA), such as, for example the x86 architecture, to the native ISA that is executed by the processors or cores. Locks may be detected and elided during the DBT, when other optimizations, including instruction re-ordering, may also be performed. The lock elision process may further be enabled by atomicity or transactional support provided by the processor, allowing speculative execution of translated sections and detection of conflicts or faults that may trigger roll back of the executed section. In some embodiments, the lock elision process (or optimization) may be dynamically throttled back if it is determined that the removal of locks degrade performance. The term “optimization,” as used herein, generally refers to a relative improvement, for example in efficiency of code execution, rather than an absolute state.

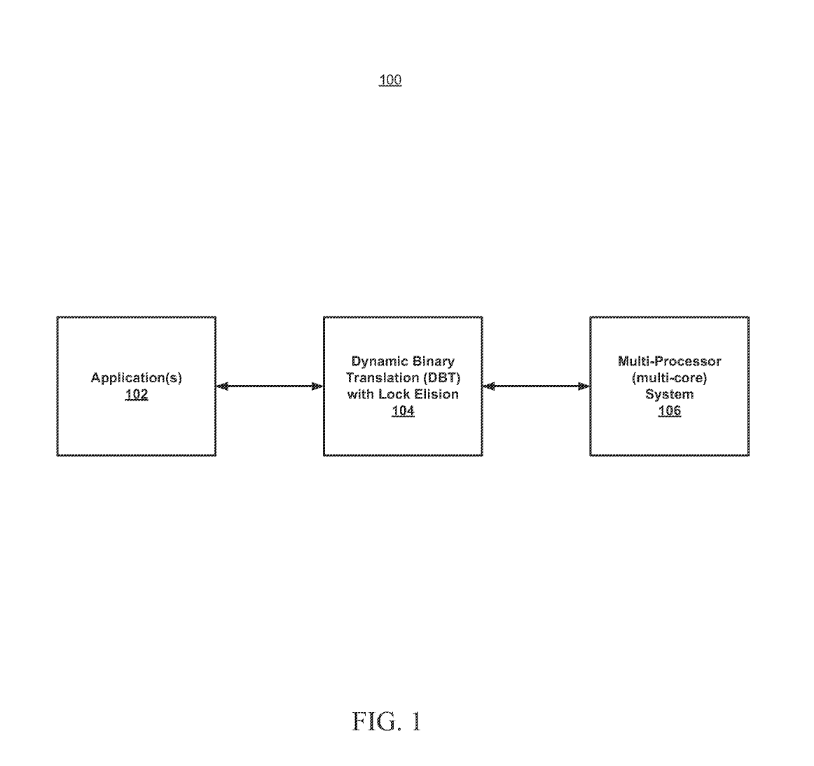

FIG. 1 illustrates a top level system diagram 100 of one example embodiment consistent with the present disclosure. A DBT module with lock elision 104 may be configured to interface between application software 102 and a multiprocessor system 106 with transactional support, as will be explained in greater detail below. Application software 102 may include locks or other synchronization mechanisms to protect critical sections of the code. DBT module 104 may be configured to dynamically detect and exploit lock elision opportunities associated with these critical code sections in connection with hardware support provided by multiprocessor system 106.

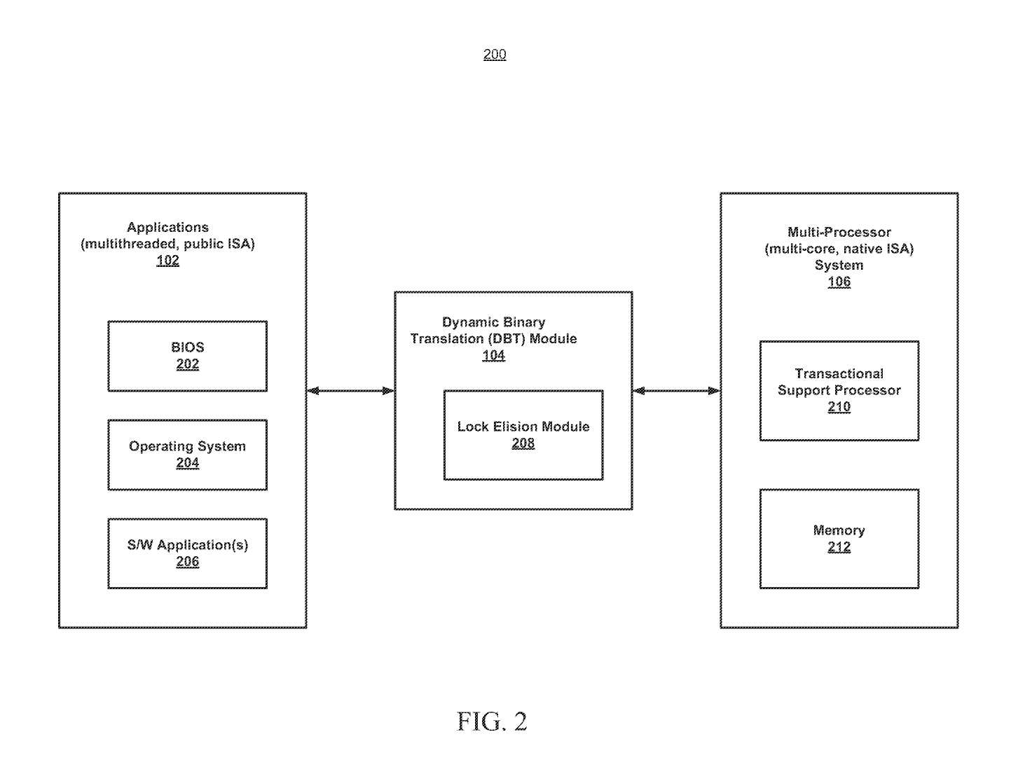

FIG. 2 illustrates a block diagram 200 of one example embodiment consistent with the present disclosure. The application software or code 102 may include the Basic Input-Output System (BIOS) 202, operating system (OS) 204, device drivers and any other software 206, including higher level applications or other user provided code, that is run on the system. The applications software 102 may typically include multi-threaded components. The application software 102 may be provided as, compiled to, or otherwise conform to a public ISA, such as, for example, the x86 architecture or a variant thereof.

DBT module 104 is shown to include lock elision module 208. DBT module 104 may be configured to translate the code from the public ISA to a native ISA that is executed by the processors 106. The native ISA may generally bear little or no resemblance to the public ISA. While the public ISA provides support for legacy code that enables access to a large collection of existing software, the native ISA may be designed for targeted goals such as, for example, increased processor performance or improved power consumption. The processors may be regularly updated to take advantage of new technology and may change their native ISA while maintaining the ability to run existing software. During the DBT process, locks and associated critical sections may be detected and opportunities for lock elision may be exploited.

Multiprocessor system 106 may include any number of processors or processing cores that may be configured to execute code in the native ISA. Multiprocessor system 106 may also include a transactional support processor 210 (or other suitable hardware) configured to provide transactional semantic support (e.g., atomicity) in the native code. A transactional or atomic region of code may begin with a checkpoint where the current architectural state of the processor (contents of cache memory, registers, etc.) is validated and stored in an internal hardware buffer. The atomic region of code is then executed speculatively, and if a fault or conflict occurs, the processor state is rolled back to the previously stored checkpoint so that any effects of the speculative execution may be undone. Otherwise, the speculative execution is committed and a new checkpoint may subsequently be established in place of the previous one, so that forward progress of code execution is achieved.

Multiprocessor system 106 may also include memory 212 for storing code and/or data or for any other purpose. The memory may include any, or all, of the following: main memory, cache memory, registers, memory mapped I/O, condition code registers, and storage for any other state information. Using any suitable cache memory coherency protocols, transactional support processor 210 may be configured to monitor accesses to memory 212, including read and write accesses, by any of the processors or cores of the system 106.

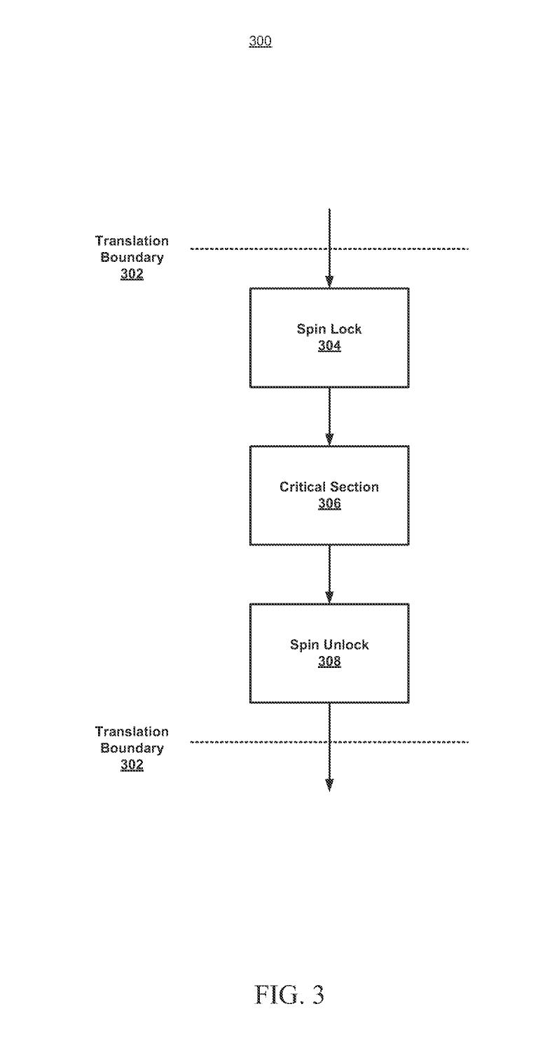

FIG. 3 illustrates a translation region 300 of another example embodiment consistent with the present disclosure. A region of translated code, for example as generated by DBT module 104, may be bounded by translation boundary 302. A critical section of code 306 may be protected by a spin lock 304 which is detected by the DBT module 104. A spin lock is an example of a relatively simple locking mechanism where one thread acquires the lock to a critical section and other threads loop (or spin) while waiting to acquire the lock. When the thread that owns the lock is finished with the critical section, it releases the lock, as in spin unlock 308. Although a spin lock is discussed herein, in connection with an example embodiment, it will be appreciated that the methods and systems of this disclosure may of course be generalized to any type of lock operation.

An example DBT for a spin lock is described below. The “original” or pre-translation code in this case is shown in x86 assembly language, where a critical section of code is bounded by a spin lock operation and a spin unlock operation.

### Original Code:

spin_lock:

| | |
|---|---|
| mov | eax, 1 |
| xchg | eax, [LOCK] |
| test | eax, eax |
| jnz | spin_lock |

// critical section

...

spin_unlock:

| | |
|---|---|
| mov | eax, 0 |
| xchg | eax, [LOCK] |

In this example, the exchange instruction (xchg), which performs an atomic read-and-write operation to memory, will continually poll the memory address LOCK until a read returns ‘0’ indicating that the processor now holds the lock. All other processors will see the LOCK variable set to ‘1’ when calling spin_lock until the lock owner writes a ‘0’ back to LOCK in the spin_unlock call. This procedure may generate a relatively large amount of coherence traffic if the lock variable is contended due to many processors writing ‘1’ to the lock variable while many other processors try to read the variable.

The DBT module translates this code to the native ISA of the processor as shown below. The instructions are broken into fundamental operations such as loads (LDs) and stores (STs). FENCE and COMMIT operations are added to achieve synchronization and transactional semantics. The FENCE operation provides memory ordering properties by forcing prior memory operations to be globally visible to other processors and/or blocking speculative re-ordering of memory operations in the processor's execution pipeline. The store buffer or write queues may be drained when the FENCE operation reaches retirement to ensure that other processors will observe the store operations as having occurred before the FENCE. The COMMIT operation causes the processor to checkpoint the current (validated to be correct) cache memory and register state, so that execution may proceed with the next speculatively optimized code interval. The COMMIT operation ensures that the speculative execution makes forward progress (i.e., avoids building an arbitrarily large atomic region) and that there is always correct state information available to the processor, to which the speculative code execution may be rolled back in case of a fault, etc.

### Translation to Native Code:

| | | |
|---|---|---|
| Original | −> | Native |

spin_lock:

| | | | |
|---|---|---|---|
| mov | eax, 1 | OR | r1, r62, 1 |

spin_lock:

| | | COMMIT | |
|---|---|---|---|
| | | FENCE | |
| xchg | eax, [LOCK] | LD | r0, [LOCK] |
| | | ST | r1, [LOCK] |
| test | eax, eax | CMP | p0, r0, r0; BRC, p0, |

spin_lock

| | |
|---|---|
| jnz | spin_lock |

| | |
|---|---|
| // critical section | // critical section |

| | |
|---|---|
| ... | ... |

| | |
|---|---|
| spin_unlock: | spin_unlock: |

| mov | eax, 0 | | |
|---|---|---|---|
| xchg | eax, [LOCK] | LD | r2, [LOCK] |

| ST | r0, [LOCK] |
|---|---|
| FENCE | |
| BR | translation_exit |

A performance penalty still exists in the translated code, however, because the store instructions (ST r1, [LOCK] and ST r0, [LOCK]) are contended between processors even in cases where the operations in the critical section rarely conflict. Thus, the DBT may further be configured to optimize the native code, as shown, for example, below.

### Optimization of Native Code:

| | |
|---|---|
| OR | r1, r62, 1 |

spin_lock:

| COMMIT | | |
|---|---|---|
| FENCE | | |
| LD | r0, [LOCK] | |
| ST | r1, [LOCK] | // “dead” store, removed during optimization |

| | |
|---|---|
| CMP | p0, r0, r0; BRC, p0, spin_lock |

| | |
|---|---|
| // critical section | // critical section |

| | |
|---|---|
| ... | ... |

| spin_unlock: | | | spin_unlock: |
|---|---|---|---|
| | LD | r2, [LOCK] | // removed during optimization |
| | ST | r0, [LOCK] | // removed during optimization |

| STCHK | [LOCK] |
|---|---|
| FENCE | |
| BR | translation_exit |

The first load, LD r0, [LOCK], makes the lock variable visible to the processor's transactional memory hardware (or memory re-ordering hardware). The atomic region is aborted if another processor tries to write to [LOCK]. The first store, ST r1, [LOCK], may be removed assuming that the second store, ST r0, [LOCK], will write back the same value to [LOCK] in memory. The second load, LD r2, [LOCK], may also be eliminated under the assumption that the lock has not changed since the “dead” store was executed. The second store, ST r0, [LOCK], is replaced by a check operation, STCHK [LOCK], which uses the processor's transactional or memory re-ordering hardware to ensure that no other store has modified the lock variable in the critical section.

In this example, if the translation reaches the translation exit branch, then the following is known, as guaranteed by processor's hardware support (e.g., module 210):
1. No other processor modified the lock variable during execution of this translation.
2. No modification of the lock variable occurred in the translation on this processor.
3. There were no read-write conflicts between the memory operations in this critical section and memory operations on any other processors, which may or may not be operating within a critical section protected by locks.
   Given these conditions, the lock will have been successfully elided. A fault is generated if an atomicity violation is detected for the critical section or the store check (STCHK) fails due to modifications to the lock variable. In that event, the code execution is rolled back to the last successfully committed checkpoint state and the DBT may proceed with execution from that point in a more conservative fashion, for example without eliding the lock, to advance past the failure.

In some embodiments, the DBT may track the count of faults and re-translate a portion of code without lock elision if a threshold is reached for that specific lock, thus providing adaptation that is not possible in a static lock elision implementation, where similar mechanisms are explicitly provided through (included in) the public ISA.

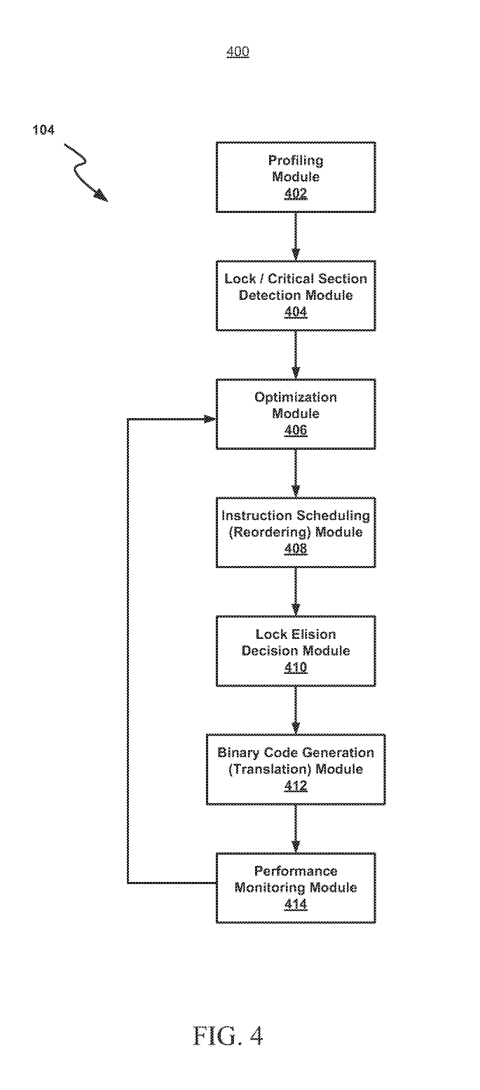

FIG. 4 illustrates a block diagram 400 of another example embodiment consistent with the present disclosure. An embodiment of the DBT module 104 is shown in greater detail to comprise a number of sub-modules. An example ordering of the modules is illustrated, but it will be appreciated that various embodiments may employ any suitable ordering and that some modules may be optional and that other additional modules (not shown) may be employed. The DBT may be configured to operate by executing translations to native code (generated by module 412) that correspond in their effect to a region of public ISA instructions in the original program. The translated region may be a locked critical section, as detected, for example by module 404. The translations may be generated by the DBT after profiling the code in module 402. The DBT may be configured to inspect all translated code and optimize the code. Optimization module 406 may be configured, for example, to perform optimizations based on heuristics and runtime behavior. The translation executes speculatively and the execution effects are either made persistent by a commit operation or rolled back in the event of misspeculation, external events, or the discovery of invalid optimizations performed by the DBT. Each commit operation advances the state of the processor by one or more equivalent public ISA instructions. The system may also be configured to support a mechanism for re-scheduling (re-ordering) memory operations statically in the DBT (e.g., module 408) and validating that public ISA memory ordering is not violated dynamically at execution.

Lock elision decision module 410 may be configured to determine whether a lock should be elided, for example based on performance monitoring of module 414, as there may be cases where it is more efficient to execute with the lock in place. The decision to elide a lock may also be based on a determination that the following conditions are met:
1. The DBT finds both a lock operation and a corresponding unlock operation in a single translation. The translation will validate that the lock variable's address are the same for lock and unlock at the time of execution.
2. The unlock operation post-dominates the critical section. That is to say, all non-faulting control flow paths within the translation will lead to the block containing the unlock operation.
3. The lock, critical section, and unlock all fit into a single atomic region supported by the processor's transactional hardware.

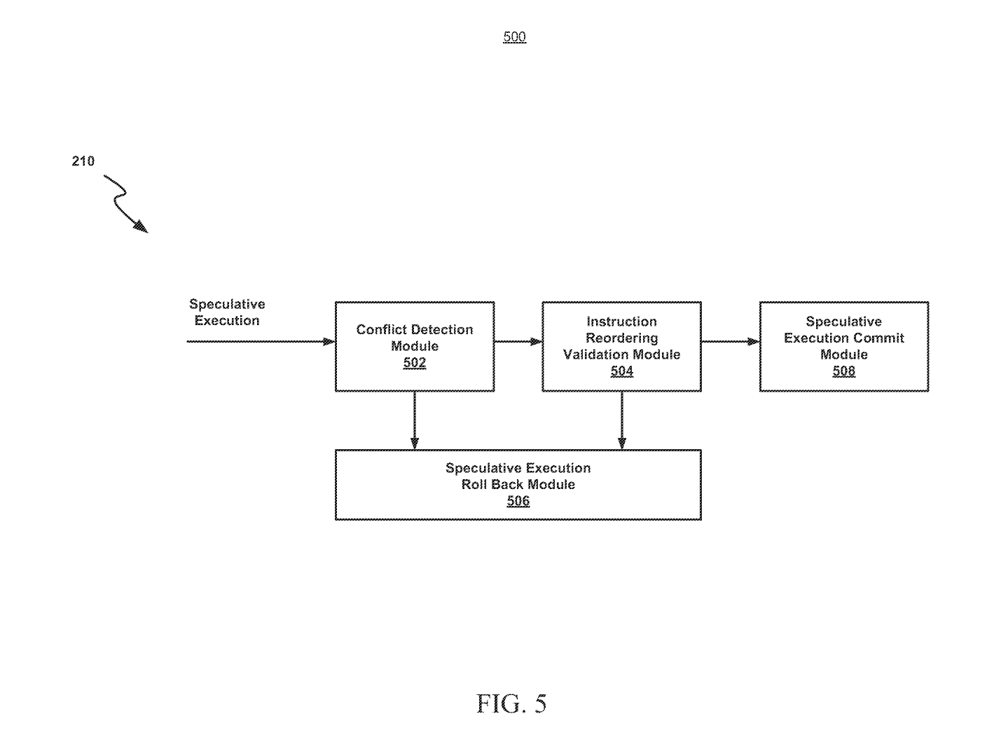

FIG. 5 illustrates a block diagram 500 of another example embodiment consistent with the present disclosure. An embodiment of the transactional support processor 210 is shown in greater detail to comprise a number of modules, which interoperate with the optimized native ISA code regions during their execution. An example ordering of the modules is illustrated, but it will be appreciated that various embodiments may employ any suitable ordering and that some modules may be optional and that other additional modules (not shown) may be employed. The conflict detection module 502 may be configured to detect conflicts that may arise during the course of the speculative execution. For example, memory read and write operations within a translation may set a speculative attribute bit for stores (or observation bit for loads) associated with a line (region) of the cache memory of the processor performing the speculative execution. The attribute bit indicates that the data written to the cache is not yet known to be correct or the data were read from cache out of original memory order. The attribute bit may be configured to force a rollback to occur (e.g. by module 506) if an external entity (e.g., another thread or another processor) should request ownership of that cache line. If the speculative execution successfully reaches a commit operation, the attribute bits associated with the cache may be cleared (e.g., module 508). In other words, the data in the cache and order of memory accesses to them have been validated. Multiple concurrent readers executing on multiple processors may be allowed without rollback, however, as long as only one writer is guaranteed to gain exclusive access to the cache line, as defined by cache memory coherency protocols. If, however, a misspeculation occurs and the processor performs a rollback to the last successfully committed state, the data cache may discard all the cache lines with the speculative attribute bit set. This will automatically restore the last valid non-speculative state.

Instruction reordering validation module 504 may be configured to dynamically validate, during execution, the instruction re-ordering that may have been statically performed by the DBT. In the event of an invalid re-ordering, a rollback may be forced (module 506), and a re-translation may be performed by the DBT to alter or eliminate the offending instruction re-order.

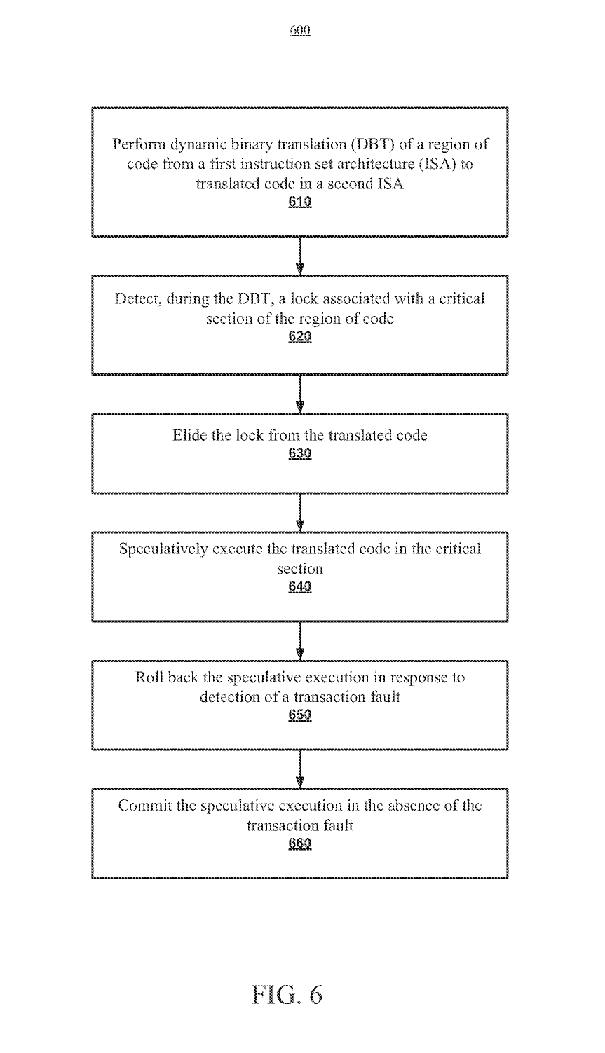

FIG. 6 illustrates a flowchart of operations 600 of another example embodiment consistent with the present disclosure. The operations provide a method for lock elision. At operation 610, a DBT is performed on a region of code from a first instruction ISA to translated code in a second ISA. The first ISA may be a public ISA while the second ISA is native to the processor. At operation 620, during the DBT, a lock associated with a critical section of the region of code is detected. At operation 630, the lock is elided from the translated code. At operation 640, the translated code in the critical section is speculatively executed. At operation 650, in response to detection of a transaction fault, the speculative execution is rolled back. At operation 660, in the absence of a transaction fault, the speculative execution is committed.

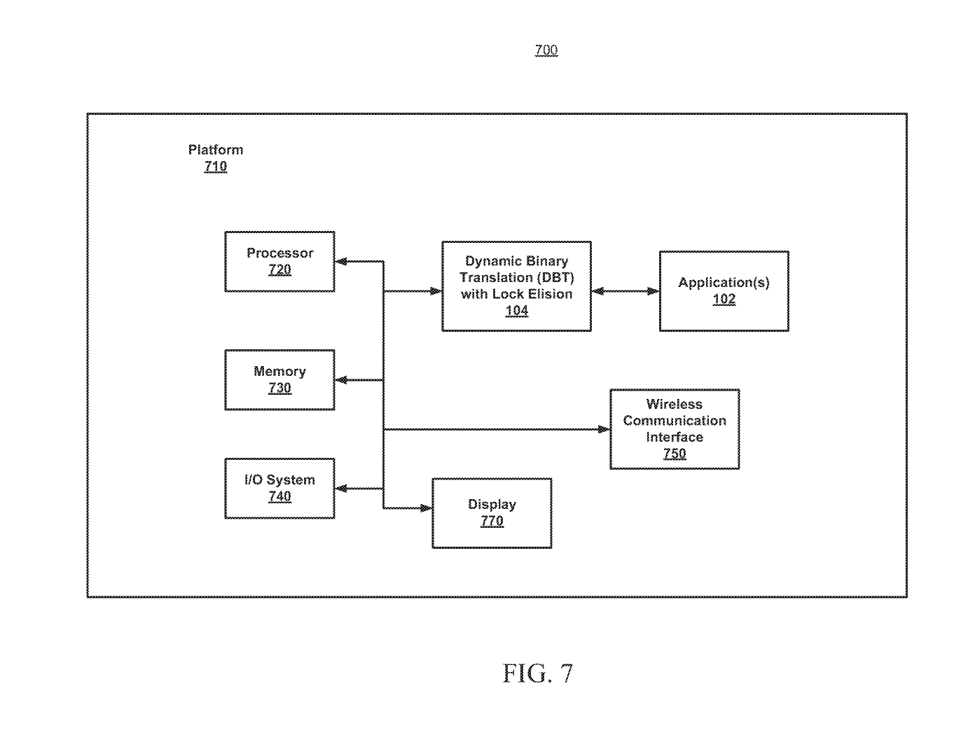

FIG. 7 illustrates a top level system diagram 700 of one example embodiment consistent with the present disclosure. The system 700 may be a hardware platform 710 or computing device such as, for example, a smart phone, smart tablet, personal digital assistant (PDA), mobile Internet device (MID), convertible tablet, notebook or laptop computer, desktop computer, server, smart television or any other device whether fixed or mobile. The device may generally present various interfaces to a user via a display 770 such as, for example, a touch screen, liquid crystal display (LCD) or any other suitable display type.

The system 700 is shown to include a processor 720. In some embodiments, processor 720 may be implemented as any number of processor cores. The processor (or processor cores) may be any type of processor, such as, for example, a micro-processor, an embedded processor, a digital signal processor (DSP), a network processor, a field programmable gate array or other device configured to execute code. Processor 720 may be a single-threaded core or, a multithreaded core in that it may include more than one hardware thread context (or “logical processor”) per core. System 700 is also shown to include a memory 730 coupled to the processor 720. The memory 730 may be any of a wide variety of memories (including various layers of memory hierarchy and/or memory caches) as are known or otherwise available to those of skill in the art. System 700 is also shown to include an input/output (I0) system or controller 740 which may be configured to enable or manage data communication between processor 720 and other elements of system 700 or other elements (not shown) external to system 700. System 700 may also include wireless communication interface 750 configured to enable wireless communication between system 700 and any external entities. The wireless communications may conform to or otherwise be compatible with any existing or yet to be developed communication standards including mobile phone communication standards.

The system 700 may further include DBT module 104 configured to detect and exploit lock elision opportunities in application 102, as described previously, while performing DBT to the native code ISA of processor(s) 720.

It will be appreciated that in some embodiments, the various components of the system 700 may be combined in a system-on-a-chip (SoC) architecture. In some embodiments, the components may be hardware components, firmware components, software components or any suitable combination of hardware, firmware or software.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry,” as used in any embodiment herein, may include, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides systems, devices, methods and computer readable media for detection and exploitation of lock elision opportunities with binary translation based processors. The following examples pertain to further embodiments.

The device may include a dynamic binary translation (DBT) module to translate a region of code from a first instruction set architecture (ISA) to translated code in a second ISA and to detect and elide a lock associated with a critical section of the region of code. The device of this example may also include a processor to speculatively execute the translated code in the critical section. The device of this example may further include a transactional support processor to detect a memory access conflict associated with the critical section during the speculative execution; roll back the speculative execution in response to the detection; and commit the speculative execution in the absence of the detection.

Another example device includes the forgoing components and the memory access conflict is associated with the lock.

Another example device includes the forgoing components and the processor is further to re-execute the translated code in the critical section under the lock after the roll back is performed in response to the detected memory access conflict.

Another example device includes the forgoing components and the DBT module is further to statically reorder instructions of the region of code and the transactional support processor is further to dynamically validate the reordering during the execution.

Another example device includes the forgoing components and the DBT module is further to monitor the number of detected memory access conflicts associated with the lock, and if the number of conflicts exceeds a threshold value, perform a new DBT, and the new DBT does not include the lock elision.

Another example device includes the forgoing components and the memory access conflict includes a memory read and/or write conflict between two or more processors of a multiprocessing system.

Another example device includes the forgoing components and the DBT module is further to dynamically optimize the translated code based on execution performance measurements.

Another example device includes the forgoing components and the DBT module is further to insert an instruction into the translated code, the instruction to cause the effects of a memory operation that precedes the elided lock to be globally visible to processors of a multiprocessing system.

Another example device includes the forgoing components and the device is a smart phone, a laptop computing device, a smart TV or a smart tablet.

Another example device includes the forgoing components and further includes a user interface, and the user interface is a touch screen.

According to another aspect there is provided a method. The method may include performing dynamic binary translation (DBT) of a region of code from a first instruction set architecture (ISA) to translated code in a second ISA. The method of this example may also include detecting, during the DBT, a lock associated with a critical section of the region of code. The method of this example may further include eliding the lock from the translated code. The method of this example may further include speculatively executing the translated code in the critical section. The method of this example may further include rolling back the speculative execution in response to detection of a transaction fault. The method of this example may further include committing the speculative execution in the absence of the transaction fault.

Another example method includes the forgoing operations and further includes re-executing the translated code in the critical section under the lock, after performing the roll back in response to the transaction fault.

Another example method includes the forgoing operations and further includes statically reordering instructions of the region of code during the DBT and dynamically validating the reordering during the execution.

Another example method includes the forgoing operations and further includes monitoring the number of transaction faults associated with the lock, and if the number of transaction faults exceeds a threshold value, performing a new DBT, and the new DBT does not include the lock elision.

Another example method includes the forgoing operations and the transaction fault is generated by an access conflict to memory associated with the lock and/or the critical section.

Another example method includes the forgoing operations and the DBT further includes dynamically optimizing the translated code based on execution performance measurements.

Another example method includes the forgoing operations and the DBT further includes inserting an instruction into the translated code, the instruction to cause the effects of a memory operation that precedes the elided lock to be globally visible to processors of a multiprocessing system.

According to another aspect there is provided a system. The system may include a means for performing dynamic binary translation (DBT) of a region of code from a first instruction set architecture (ISA) to translated code in a second ISA. The system of this example may also include a means for detecting, during the DBT, a lock associated with a critical section of the region of code. The system of this example may further include a means for eliding the lock from the translated code. The system of this example may further include a means for speculatively executing the translated code in the critical section. The system of this example may further include a means for rolling back the speculative execution in response to detection of a transaction fault. The system of this example may further include a means for committing the speculative execution in the absence of the transaction fault.

Another example system includes the forgoing components and further includes a means for re-executing the translated code in the critical section under the lock, after performing the roll back in response to the transaction fault.

Another example system includes the forgoing components and further includes a means for statically reordering instructions of the region of code during the DBT and means for dynamically validating the reordering during the execution.

Another example system includes the forgoing components and further includes a means for monitoring the number of transaction faults associated with the lock, and if the number of transaction faults exceeds a threshold value, means for performing a new DBT, and the new DBT does not include the lock elision.

Another example system includes the forgoing components and the transaction fault is generated by an access conflict to memory associated with the lock and/or the critical section.

Another example system includes the forgoing components and the DBT further includes means for dynamically optimizing the translated code based on execution performance measurements.

Another example system includes the forgoing components and the DBT further includes means for inserting an instruction into the translated code, the instruction to cause the effects of a memory operation that precedes the elided lock to be globally visible to processors of a multiprocessing system.

According to another aspect there is provided at least one computer-readable storage medium having instructions stored thereon which when executed by a processor, cause the processor to perform the operations of the method as described in any of the examples above.

According to another aspect there is provided an apparatus including means to perform a method as described in any of the examples above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A device for lock elision, said device comprising:
a dynamic binary translation (DBT) module to translate a region of code from a first instruction set architecture (ISA) to translated code in a second ISA and to detect and elide a lock associated with a critical section of said region of code;
a processor to speculatively execute said translated code in said critical section; and
a transactional support processor to:
detect a memory access conflict associated with said critical section during said speculative execution;
roll back said speculative execution in response to said detection; and
commit said speculative execution in the absence of said detection.

2. The device of claim 1, wherein said processor is further to re-execute said translated code in said critical section under said lock after said roll back is performed in response to said detected memory access conflict.

3. The device of claim 1, wherein said DBT module is further to statically reorder instructions of said region of code and said transactional support processor is further to dynamically validate said reordering during said execution.

4. The device of claim 1, wherein said DBT module is further to monitor the number of detected memory access conflicts associated with said lock, and if said number of conflicts exceeds a threshold value, perform a new DBT, wherein said new DBT does not comprise said lock elision.

5. The device of claim 1, wherein said memory access conflict comprises a memory read or write conflict between two or more processors of a multiprocessing system.

6. The device of claim 1, wherein said DBT module is further to dynamically optimize said translated code based on execution performance measurements.

7. The device of claim 1, wherein said DBT module is further to insert an instruction into said translated code, said instruction to cause the effects of a memory operation that precedes the elided lock to be globally visible to processors of a multiprocessing system.

8. The device of claim 1, wherein said device is a smart phone, a laptop computing device, a smart TV or a smart tablet.

9. The device of claim 1, further comprising a user interface, wherein said user interface is a touch screen.

10. A method for lock elision, said method comprising:
performing dynamic binary translation (DBT) of a region of code from a first instruction set architecture (ISA) to translated code in a second ISA;
detecting, during said DBT, a lock associated with a critical section of said region of code;
eliding said lock from said translated code;
speculatively executing said translated code in said critical section;
rolling back said speculative execution in response to detection of a transaction fault; and
committing said speculative execution in the absence of said transaction fault.

11. The method of claim 10, further comprising re-executing said translated code in said critical section under said lock, after performing said roll back in response to said transaction fault.

12. The method of claim 10, further comprising statically reordering instructions of said region of code during said DBT and dynamically validating said reordering during said execution.

13. The method of claim 10, further comprising monitoring the number of transaction faults associated with said lock, and if said number of transaction faults exceeds a threshold value, performing a new DBT, wherein said new DBT does not comprise said lock elision.

14. The method of claim 10, wherein said transaction fault is generated by an access conflict to memory associated with said critical section.

15. The method of claim 10, wherein said DBT further comprises dynamically optimizing said translated code based on execution performance measurements.

16. The method of claim 10, wherein said DBT further comprises inserting an instruction into said translated code, said instruction to cause the effects of a memory operation that precedes the elided lock to be globally visible to processors of a multiprocessing system.

17. At least one computer-readable storage medium having instructions stored thereon which when executed by a processor result in the following operations for lock elision, said operations comprising:
performing dynamic binary translation (DBT) of a region of code from a first instruction set architecture (ISA) to translated code in a second ISA;
detecting, during said DBT, a lock associated with a critical section of said region of code;
eliding said lock from said translated code;
speculatively executing said translated code in said critical section;
rolling back said speculative execution in response to detection of a transaction fault; and
committing said speculative execution in the absence of said transaction fault.

18. The computer-readable storage medium of claim 17, further comprising the operation of re-executing said translated code in said critical section under said lock, after performing said roll back in response to said transaction fault.

19. The computer-readable storage medium of claim 17, further comprising the operations of statically reordering instructions of said region of code during said DBT and dynamically validating said reordering during said execution.

20. The computer-readable storage medium of claim 17, further comprising the operations of monitoring the number of transaction faults associated with said lock, and if said number of transaction faults exceeds a threshold value, performing a new DBT, wherein said new DBT does not comprise said lock elision.

21. The computer-readable storage medium of claim 17, wherein said transaction fault is generated by an access conflict to memory associated with said critical section.

22. The computer-readable storage medium of claim 17, wherein said DBT further comprises the operation of dynamically optimizing said translated code based on execution performance measurements.

23. The computer-readable storage medium of claim 17, wherein said DBT further comprises the operation of inserting an instruction into said translated code, said instruction to cause the effects of a memory operation that precedes the elided lock to be globally visible to processors of a multiprocessing system.
